(19) United States
(12) Patent Application Publication
(10) Pub. No.: US 2007/0041039 A1
(43) Pub. Date: Feb. 22, 2007

(54) Print system control method notifying user before job information is transmitted that print request is permitted, and information processor, information terminal and program product for controlling the same

(75) Inventor: Takayuki Doui, Kawanishi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 11/274,087

(22) Filed: Nov. 16, 2005

(30) Foreign Application Priority Data
Aug. 22, 2005 (JP) 2005-240040

(51) Int. Cl. G06F 3/12; G06F 15/00

(52) U.S. Cl. 358/1.15

(57) ABSTRACT

A print system includes a printer, an information terminal and an information processor. The information terminal stores driver identification information, which is information for identifying a driver generating job information for operating the printer. The information processor receives job information transmitted from the information terminal, and causes the printer to perform a print operation based on the received job information. The information terminal transmits the driver identification information to the information processor before the job information is transmitted. If the information terminal receives information from the information processor indicating that the driver identification information is appropriate information the information terminal transmits the job information to the information processor.

This application is based on Japanese Patent Application No. 2005-240040 filed with the Japan Patent Office on Aug. 22, 2005, the entire content of which is hereby incorporated by reference.

### BACKGROUND OF THE INVENTION

1. Field of the Invention

The present invention relates to print systems and in particular to methods of controlling the print system including an information terminal and an information processor operative in response to job information having been received from the information terminal to cause a printer to execute a print based on the job information, and information processors, information terminals and program products for controlling them.

2. Description of the Related Art

Conventionally for print systems techniques have been disclosed that restrict the use of a function of a device between different users.

For example, Japanese Laid-Open Patent Publication No. 10-161823 discloses that in a print system a server computer refers to a database and from what is to be printed included in a print request issued to a printer and user information whether in response to the request the printer may print or not is determined.

In the conventional print system as described above, however, if a user selects a function of a device and transmits job information (a print job) to a printer a rejection can be determined after the job information is transmitted. In such a case, the transmission of the job information by the user will be useless.

### SUMMARY OF THE INVENTION

The present invention has been made to overcome such disadvantage and it contemplates restricting the use of a device in a print system and also avoiding a time wastefully consumed as a user transmits job information which will consequently be rejected.

The present invention provides a method of controlling a print system that relates to a print system including a printer, an information terminal and an information processor. The information terminal stores driver identification information serving as information for identifying a driver generating job information for operating the printer. The information processor receives job information transmitted from the information terminal and causes the printer to perform a print operation based on the received job information. The present method includes the steps of: transmitting the driver identification information from the information terminal to the information processor prior to transmitting the job information; making a decision in the information processor as to whether the driver identification information received from the information terminal is appropriate information; and after the information terminal has received a decision that the driver identification information transmitted is appropriate information, transmitting the job information form the information terminal to the information processor.

The present invention provides an information processor information processor connected to a printer and an information terminal. The information terminal stores driver identification information serving as information for identifying a driver generating job information for operating the printer, and the information processor includes: a receiver receiving job information transmitted from the information terminal; an executor executing a process, as based on the job information, to cause the printer to effect a print operation; a determinator determining whether the driver identification information transmitted by the information terminal before the job information is transmitted is appropriate information; and a notifier providing a permission to the information terminal to issue a job if the determinator determines that the driver identification information received from the information terminal is appropriate information.

The present invention provides an information terminal transmitting job information to an information processor to cause a printer to print as based on the job information, the information terminal including: a storage storing driver identification information serving as information for identifying a driver generating job information for operating the printer; a transmitter transmitting the driver identification information stored in the storage to the information processor before the job information is transmitted; a receiver receiving notification from the information processor that the driver identification information transmitted at the transmitter is appropriate information; and a job transmitter transmitting the job information to the information processor after the receiver receives the notification.

The present invention provides a program product for controlling an information processor connected to a printer and an information terminal. The information terminal stores driver identification information serving as information for identifying a driver generating job information for operating the printer and the information processor includes a receiver receiving job information transmitted from the information terminal and an executor executing a process, as based on the job information, to cause the printer to effect a print operation, and the program product causes the information processor to execute the steps of: determining whether the driver identification information transmitted by the information terminal before the job information is transmitted is appropriate information; and if a decision is made that the driver identification information received from the information terminal is appropriate information, then providing a permission to the information terminal to issue a job.

The present invention in another aspect provides a program product for controlling an information terminal transmitting job information to an information processor to cause a printer to print as based on the job information, the program product causing the information terminal to execute the steps of: storing driver identification information serving as information for identifying a driver generating job information for operating the printer; transmitting the driver identification information to the information processor before the job information is transmitted; receiving notification from the information processor that the driver identification information transmitted is appropriate information; and transmitting the job information to the information processor after the notification is received.

In accordance with the present invention, from an information terminal to an information processor before job information is transmitted driver identification information stored in the information terminal is transmitted and if a decision is made that the driver identification information is appropriate information the information processor causes a printer to effect a print operation based on the job information.

In accordance with in the present invention whether a print operation based on job information is permitted or not is determined before the job information is transmitted from the information terminal to the information processor.

This can prevent a user from transmitting job information that will be rejected, and thus wasting time.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a configuration the present print system in one embodiment.

FIGS. 2, 3 and 4 are block diagrams for illustrating how the server, information processing terminal, and image formation apparatus of FIG. 1, respectively, are controlled.

FIGS. 5-9 are a flowchart of a process executed in the print system of FIG. 1 as a print driver is started.

FIGS. 10 and 11 show one example of a screen displayed on a display of the information processing terminal of FIG. 1.

### DESCRIPTION OF THE PREFERRED EMBODIMENTS

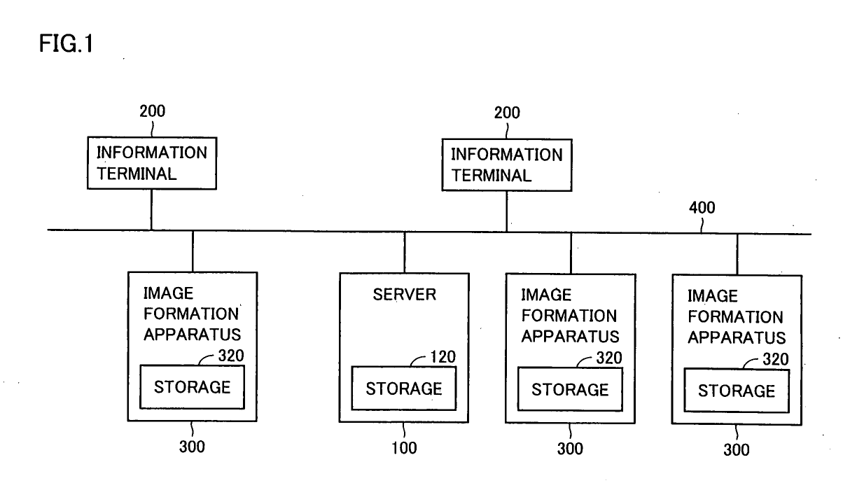

FIG. 1 schematically shows a configuration of the present print system in one embodiment. The print system includes a single server 100, a plurality of information terminals 200, and an image formation apparatus 300, connected together by a bus 400. Server (or an information processor) 100 and image formation apparatus 300 include storage devices 120 and 230, respectively. Note that each component shown in FIG. 1 is not limited in number and the present print system may have a number thereof other than shown in FIG. 1.

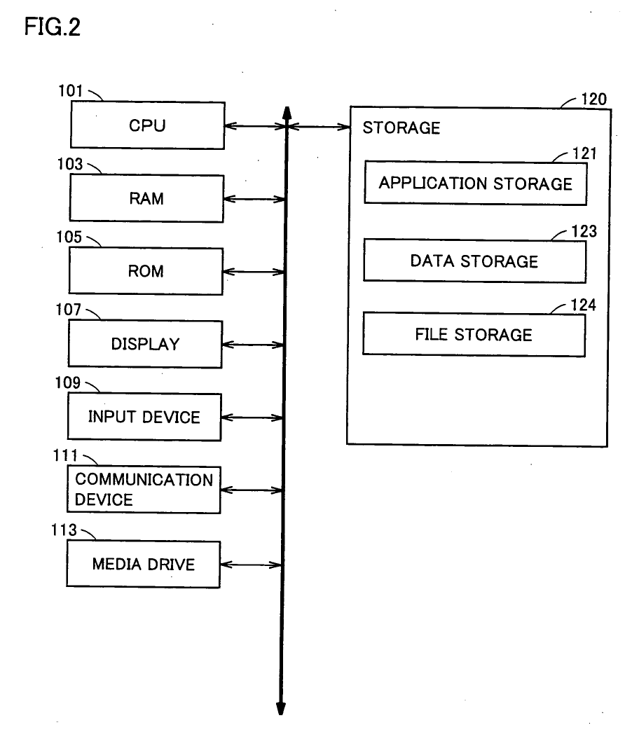

FIG. 2 is a block diagram for illustrating how the server of FIG. 1 is controlled.

With reference to the figure, server 100 includes a central processing unit (CPU) 101 generally controlling the server, a random access memory (RAM) 103 temporarily storing data, a read only memory (ROM) 105 storing a program, a constant and the like, a display 107 displaying information, an input device 109 receiving external information, a communication device 111 provided to communicate information with an apparatus and the like through bus 400, a media drive 113 writing and reading information to and from a compact disc read only memory (CD-ROM) or similar storage media, and a storage 120 storing a variety of information. Display 107 and input device 109 can also be configured of a liquid crystal display and a touch panel placed on thereon.

Storage 120 includes an application storage 121 storing an application program executed by CPU 101, a data storage 123 storing a variety of data such as data utilized for an application, and a file storage 123 storing job information, which is information serving as a source causing image formation apparatus 300 to print.

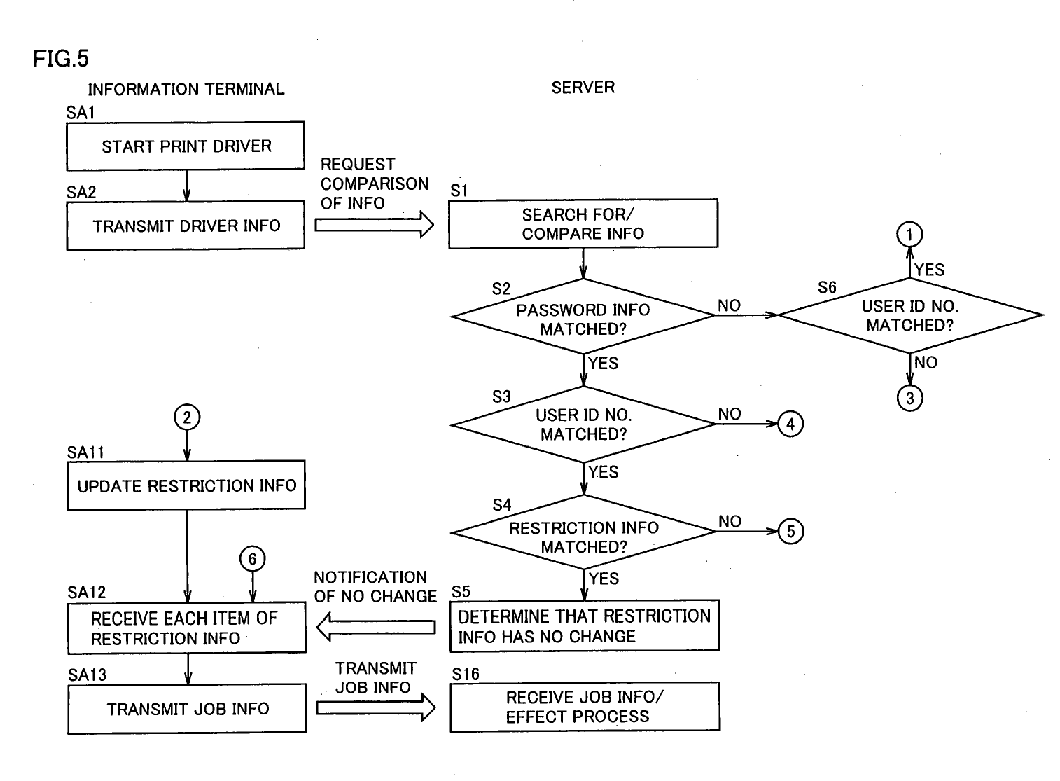

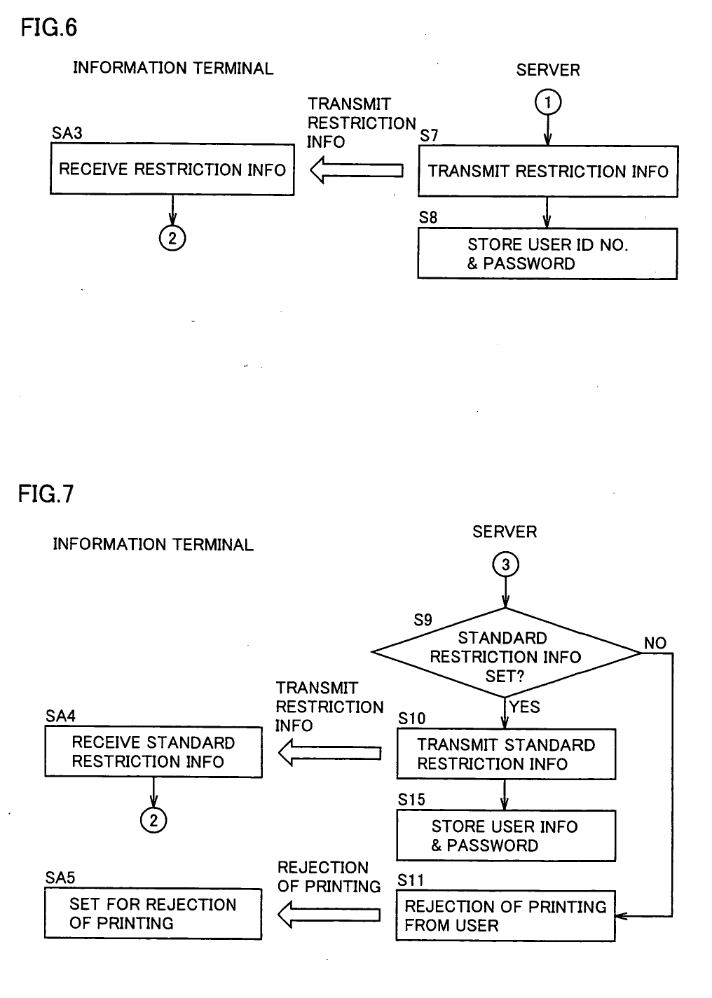

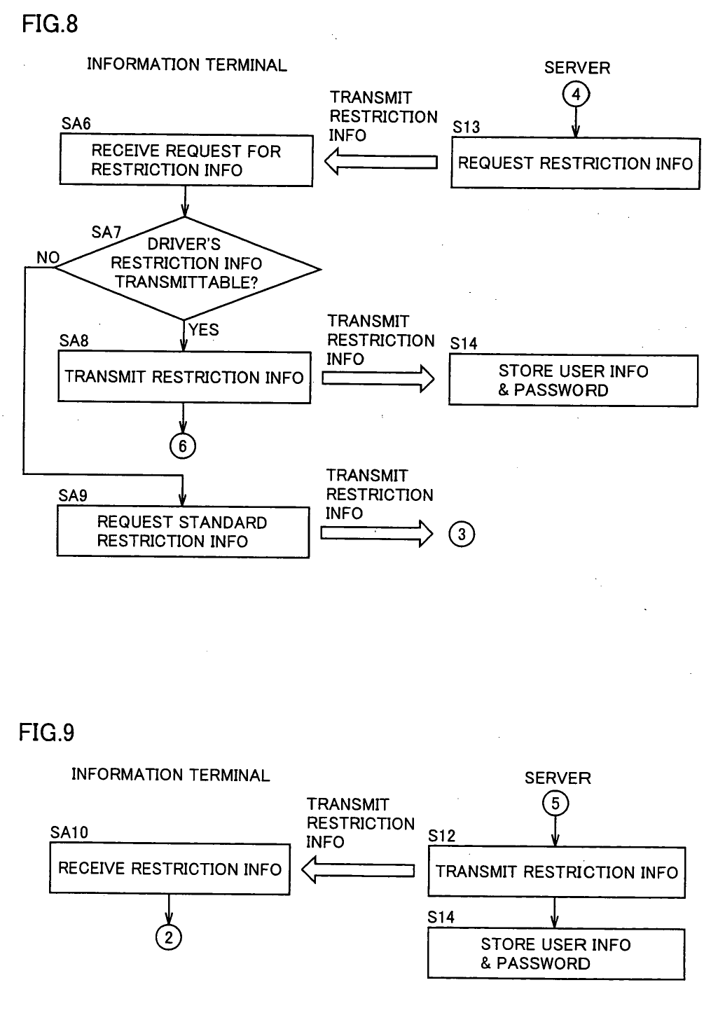

Application storage 121 stores an application program including for example a program of a process described hereinafter with reference to FIGS. 5-9, a program transmitting to image formation apparatus 300 job information stored in file storage 127, and the like.

A table 1 shows one example of printing information stored in data storage 123.

TABLE 1

| password | | | size of | double | | | | | | | |
|---|---|---|---|---|---|---|---|---|---|---|---|
| info (driver | user | No. of | sheet | sided | | | color/black | | toner | sheet feed | sheet output |
| ID No.) | ID No. | copies | output | printing | sheet type | N in 1 | & white | resolution | saving | tray | dray |
| standard | — | 1 | A4 | effective | ordinary | 2 in 1 | black & | 300 dpi | effective | tray 1 | main tray |
| restriction | | | | | sheet | | white | | | | |
| information | | | | | | | | | | | |
| v1.00- | Adminis- | no | no | no | no | no | no | no | no | no | no |
| custom1 | trator | restriction | restriction | restriction | restriction | restriction | restriction | restriction | restriction | restriction | restriction |
| v1.00- | User_A | 1/2 | A4/B5 | effective | ordinary | no | black & | 300 dpi/ | no | tray 1/ | no |
| custom2 | | | | | sheet/OHP | restriction | white | 600 dpi | restriction | tray 2 | restriction |
| v1.00- | User_B | 1 | A4 | effective | ordinary | 2 in 1 | black & | 300 dpi | no | tray 1 | no |
| custom3 | | | | | sheet | | white | | restriction | | restriction |
| v1.00- | User_C | 1/2 | A4/B5 | effective | ordinary | no | black & | 300 dpi/ | no | tray 1/ | no |
| custom2 | | | | | sheet/OHP | restriction | white | 600 dpi | restriction | tray 2 | restriction |

The printing information includes password information of a print driver (a program generating job information for causing a printer of image formation apparatus 300 or the like to operate) assigned in the print system to each user. More specifically, table 1 includes password information v1.00-custom1, v1.00-custom2 and v1.00-custom3 serving as information identifying three types of customized print drivers, respectively, and password information serving as “standard restriction information” indicating a standard print driver version.

Furthermore, the printing information also includes a user identification (ID) number serving as information for identifying each user. More specifically, four types of user ID numbers Administer and User_A, User_B, User_C are associated with v1.00-custom1, v1.00-custom2 and v1.00-custom3, respectively. This means that: for a user with Administor assigned as his/her user ID number the print driver of the version of v1.00-custom1 is permitted; for users with User_A and User_C assigned as their user ID numbers the print driver of the version of v1.00-custom2 is permitted; and a user with User_B assigned as his/her user ID number the print driver of the version of v1.00-custom3 is permitted. Furthermore, that in table 1 no user ID number is associated with the “standard restriction information” means that the “standard restriction information” or the standard print driver version is a version permitted for a user other than those indicated above.

Furthermore, the printing information includes restriction information associated with each password information and indicating a restriction on a setting for printing.

The restriction information specifically includes: the number of copies; the size of a sheet output; double sided printing; sheet type; N in 1; color/black and white; resolution; toner saving; and sheet feed and output trays.

If a “number of copies” cell indicates “1” it means that for the corresponding version the number of copies that can be designated is only “1”. If a “number of copies” cell indicates “no restriction” it means that for the corresponding version no restriction is placed in designating the number of copies.

If a “size of sheet output” cell indicates “A4/A5” it means that for the corresponding version the size that can be designated is A4 or A5.

If a “double sided printing” cell indicates “effective” it means that for the corresponding version, double sided printing can be designated.

If a “sheet type” cell indicates “ordinary sheet, sheet for overhead projector (OHP)” it means that for the corresponding version an ordinary sheet or a sheet for OHP can be designated as a sheet employed to output a job.

If an “N in 1” cell indicates “2 in 1” it means that for the corresponding version, outputting a job is limited to combining two pages of an original in a single sheet and thus printing them on the sheet for output. Note that an “N in 1” cell indicating “no restriction” indicates that for the corresponding version two pages of an original may be combined in a single sheet and thus printed or may each be printed on a single sheet for output.

If a “color/black and white” cell indicates “black and white” it means the for the corresponding version, outputting a job is limited to outputting in black and white and cannot be done in colors.

If a “resolution” cell indicates “300 dpi, 600 dpi” it means that for the corresponding version, 300 or 600 dpi can be selected as a resolution of an image output.

If a “toner saving” cell indicates “effective” it means that for the corresponding version a toner saving function is constantly set effective. The toner saving function is a function providing reduced consumption of toner by slightly reducing an image in density to be pale for example when the image is printed on a trial basis or is not required to have high quality, or the like. If the cell indicates “no restriction” it means that for the corresponding version the toner saving function may or may not be set effective.

“Sheet feed tray” and “sheet output tray” cells indicate information of which tray is designated for the corresponding version to feed or receive a sheet in image formation apparatus 300. If the cell indicates “no restriction” “it means that for the corresponding version a user can designate a tray feeding or receiving a sheet, as desired.

File storage 123 stores job information transmitted from information terminal 200 such that the job information is associated with information specifying the user having performed the transmission process (e.g., a user ID number, as described above).

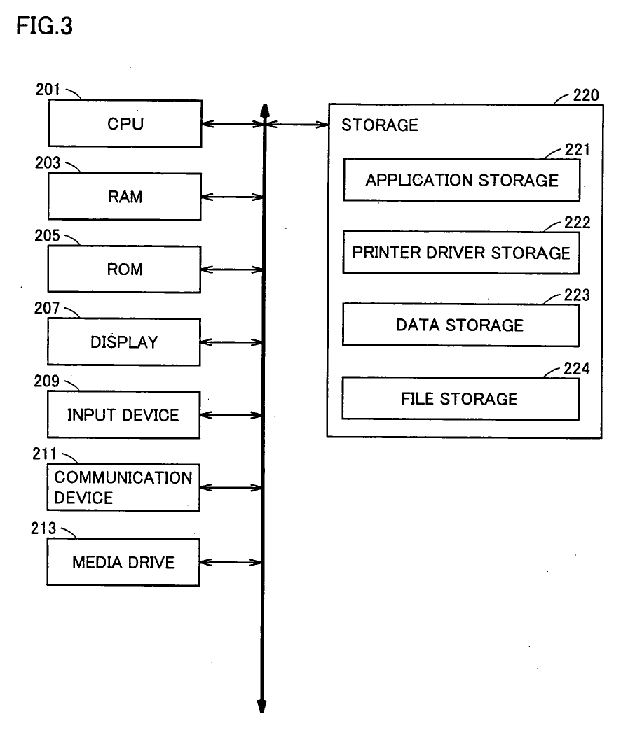

FIG. 3 is a block diagram for illustrating how information terminal information terminal 200 is controlled.

With reference to the figure, information terminal 200 includes a CPU 201 generally controlling the terminal, a RAM 203 temporarily storing data, a ROM 205 storing a program, a constant and the like, a display 207 displaying information, an input device 209 receiving external information, a communication device 211 provided to communicate information with another apparatus and the like through bus 400, a media drive 213 writing and reading information to and from a CD-ROM or similar storage media, and a storage 220 storing a variety of information. Display 207 and input device 209 can also be configured of a liquid crystal display and a touch panel placed on thereon.

Storage 220 includes an application storage 221 storing an application program executed by CPU 201, a printer driver storage 222 storing a program generating job information for causing image formation apparatus 300 to print as based on the job information, i.e., a print driver, a data storage 223 storing a variety of data such as data utilized for an application, and a file storage 224 storing the job information.

Application storage 121 stores an application program including for example a program creating a document.

Printer driver storage 222 stores a print driver basically customized for each user. More specifically, printer driver 222 stores a plurality of customized print drivers and which user logs in information terminal 200 determines which type of print driver should be started.

A table 2 indicates one example of driver information stored in data storage 223.

TABLE 2

| password | | | size of | double | | | | | | | |
|---|---|---|---|---|---|---|---|---|---|---|---|
| info (driver | user | No. of | sheet | sided | | | color/black | | toner | sheet feed | sheet output |
| ID No.) | ID No. | copies | output | printing | sheet type | N in 1 | & white | resolution | saving | tray | dray |
| v1.00- | User_A | 1/2 | A4/B5 | effective | ordinary | no | black & | 300 dpi/ | no | tray 1/ | no |
| custom2 | | | | | sheet/OHP | restriction | white | 600 dpi | restriction | tray 2 | restriction |

As well as the printing information described with reference to table 1, the driver information also includes information corresponding to items “password information”, “user ID number”, “number of copies”, “size of sheet output”, “double sided printing”, “sheet type”, “N in 1”, “color/black and white”, “resolution”, “toner saving”, “sheet feed tray”, and “sheet output tray”. In other words, the driver information and the printing information are basically information comprised of the same items.

Note that, as indicated in table 2, only the printing information having a user ID number “User_A” is stored.

Data storage 223 has its stored information updated when a user who has logged in starts a print driver so that a series of information corresponding to the user is added, as will be described hereinafter.

Data storage 223 having been updated can for example store information as indicated in a table 3.

TABLE 3

| password | | | size of | double | | | | | | | |
|---|---|---|---|---|---|---|---|---|---|---|---|
| info (driver | user | No. of | sheet | sided | | | color/black | | toner | sheet feed | sheet output |
| ID No.) | ID No. | copies | output | printing | sheet type | N in 1 | & white | resolution | saving | tray | dray |
| v1.00- | Adminis- | no | no | no | no | no | no | no | no | no | no |
| custom1 | trator | restriction | restriction | restriction | restriction | restriction | restriction | restriction | restriction | restriction | restriction |
| v1.00- | User_A | 1/2 | A4/B5 | effective | ordinary | no | black & | 300 dpi/ | no | tray 1/ | no |
| custom2 | | | | | sheet/OHP | restriction | white | 600 dpi | restriction | tray 2 | restriction |
| v1.00- | User_B | 1 | A4 | effective | ordinary | 2 in 1 | black & | 300 dpi | no | tray 1 | no |
| custom3 | | | | | sheet | | white | | restriction | | restriction |
| v1.00- | User_C | 1/2 | A4/B5 | effective | ordinary | no | black & | 300 dpi/ | no | tray 1/ | no |
| custom2 | | | | | sheet/OHP | restriction | white | 600 dpi | restriction | tray 2 | restriction |

Table 3 shows a storage attained from that of table 2 when three users having user ID numbers Administer, User_B and User_C starts their print drivers in information terminal 200.

File storage 224 stores a file created in information terminal 220, a file received from another terminal or the like, and the like. The printer driver adds to a file stored in file storage 224 information for printing, such as the number of prints, and transmits it as a job to server 100.

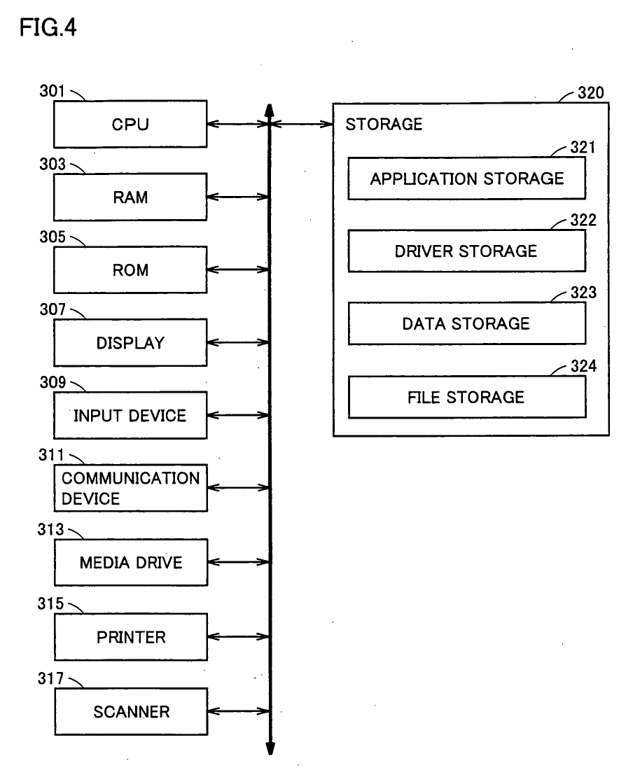

FIG. 4 is a block diagram for illustrating how image formation apparatus 300 is controlled.

With reference to the figure, image formation apparatus 300 includes a CPU 301 generally controlling the apparatus, a RAM 303 temporarily storing data, a ROM 305 storing a program, a constant and the like, a display 307 displaying information, an input device 309 receiving external information, a communication device 311 provided to communicate information with another apparatus through bus 400, a media drive 313 writing and reading information to and from a CD-ROM or similar storage media, a printer 315 executing a print operation, a scanner 317 reading an original to generate image data, and a storage 320 storing a variety of information. Display 307 and input device 309 can also be configured of a liquid crystal display and a touch panel placed on thereon.

Storage 320 includes an application storage 321 storing an application program executed by CPU 301, a driver storage 322 storing a program causing printer 315 to operate, i.e., a print driver, and a program causing scanner 317 to operate, i.e., a scanner driver, a data storage 323 storing a variety of data such as data utilized for an application, and a file storage 324 storing job information, which is information serving as a source causing printer 315 to print, an image file generated by scanner 317, and the like.

In the present print system when information terminal 200 has a print driver started to print a file CPU 201 transmits the driver information of tables 2 and 3 that corresponds to a currently logged in user and password information corresponding thereto to server 100 before information required to print the file (i.e., job information) is transmitted. In response, server 100 makes a variety of decisions with respect to the received driver information and executes a process based on the decisions.

The present print system effects a process as a print driver is stared, as described above, as will be described hereinafter with reference to the flowchart shown in FIGS. 5-9. The figures show processes effected by CPU 201 of information terminal 200 and CPU 101 of server 100, respectively.

Initially when information terminal 200 has a print driver started (step SA1) CPU 201 proceeds to step SA2 to transmit driver information corresponding to a user currently logging in server 100.

In server 100 CPU 101 responds to receiving the driver information by proceeding to step S1 to store the received information to RAM 104 for a subsequent process.

Then in step S2 CPU 101 extracts password information from the driver information stored in RAM 103 and determines whether password information identical to the extracted password information is stored in the printing information stored in data storage 122. If so CPU 101 proceeds to step S3, otherwise to step S6.

In step S6 CPU 101 extracts a user ID number from the driver information stored in RAM 103 and determines whether the extracted user ID number is stored in the printing information stored in data storage 122. If so CPU 101 proceeds to step S7, otherwise to step S9.

In step S7 CPU 101 transmits to information terminal 200 the information included in the printing information that is associated with the extracted user ID number (i.e., password information and restriction information), and in step S8 CPU 101 updates the printing information and completes the process, and awaits for a process effected by information terminal 200.

In information terminal 200 in response to CPU 101 of server 100 transmitting the password and restriction information at step S7 CPU 201 proceeds to step SA3 to receive the password and restriction information and proceeds to step SA11.

In server 100 CPU 101 proceeds to step S9 to determine whether the printing information includes password information set as “standard restriction information”. If so CPU 101 proceeds to step S10, otherwise to step 1.

In step S10 CPU 101 transmits to information processing terminal 100 the specific setting in the printing information with the standard restriction information as password information, and proceeds to step S15.

In information terminal 200 in response to CPU 101 transmitting information at step S10 CPU 201 proceeds to step SA4 to effect a process to receive it and proceeds to S11.

In step S15 CPU 101 updates the printing information to add an item indicating that the password and restriction information are information corresponding to the standard restriction information and the user ID number is information corresponding to the user currently logging in information terminal 200, and awaits a process effected by information terminal 200.

In step S11 CPU 101 transmits to information terminal 200 information indicating a rejection of printing, and enters a standby state.

In response, in information terminal 200 CPU 201 proceeds to step SA5 to effect a process executed when a rejection of printing is received, and enters a standby state. The process for example includes causing display 207 to display a message accordingly.

In step S3 CPU 101 extracts a user ID number from the driver information stored in RAM 103 and determines whether the extracted user ID number is stored in association with the password information that CPU 101 has determined at S2 is stored in the printing information stored in data storage 122. If so CPU 101 proceeds to step S4, otherwise to step S13.

In step S13 CPU 101 effects a process to request information terminal 200 to transmit restriction information.

In response, in information terminal 200 CPU 201 proceeds to step SA6 to receive it and proceeds to step SA7 to determine whether driver's restriction information can be transmitted. If so CPU 201 proceeds to step SA8, otherwise to SA9 for example when the driver is not customized.

In step SA8 CPU 201 transmits the restriction information to server 100 and then proceeds to step SA12.

CPU 101 in step S14 receives the restriction information, defines a new password information in the printing information, and associates the new password information with the received restriction information and user information and thus stores it, and awaits a process effected by information processor 201.

Note that in step SA9, to server 100 information is transmitted to request it to transmit standard restriction information.

When the request is received by server 100 CPU 101 executes the process of step S9 et seq. described with reference to FIG. 7.

In step S4 CPU 101 extracts restriction information from the driver information stored in RAM 103 and determines whether the extracted restriction information is stored in association with the password information that CPU 101 has determined at S2 is stored in the printing information stored in data storage 122. If so CPU 101 proceeds to step S5, otherwise to step S12.

In step S12 CPU 101 transmits to information terminal 200 the restriction information associated with the password information that CPU 101 has determined at S2 is stored in the printing information stored in data storage 122.

In response to the transmission of the restriction information CPU 201 proceeds to step SA10 to receive the restriction information and proceeds to step SA11.

In step SA11 CPU 201 updates the driver information to be that received from server 100 and furthermore if restriction information for an additional user is received CPU 201 provides an update to add it, and proceeds to step SA12.

The driver information indicated in table 3 plus information for an additional user User D is indicated in a table 4.

TABLE 4

| password | | | size of | double | | | | | | | |
|---|---|---|---|---|---|---|---|---|---|---|---|
| info (driver | user | No. of | sheet | sided | | | color/black | | toner | sheet feed | sheet output |
| ID No.) | ID No. | copies | output | printing | sheet type | N in 1 | & white | resolution | saving | tray | dray |
| v1.00- | Adminis- | no | no | no | no | no | no | no | no | no | no |
| custom1 | trator | restriction | restriction | restriction | restriction | restriction | restriction | restriction | restriction | restriction | restriction |
| v1.00- | User_A | 1/2 | A4, B5 | effective | ordinary | no | black & | 300 dpi/ | no | tray 1/ | no |
| custom2 | | | | | sheet/OHP | restriction | white | 600 dpi | restriction | tray 2 | restriction |
| v1.00- | User_B | 1 | A4 | effective | ordinary | 2 in 1 | black & | 300 dpi | no | tray 1 | no |
| custom3 | | | | | sheet | | white | | restriction | | restriction |
| v1.00- | User_C | 1/2 | A4, B5 | effective | ordinary | no | black & | 300 dpi/ | no | tray 1/ | no |
| custom2 | | | | | sheet/OHP | restriction | white | 600 dpi | restriction | tray 2 | restriction |
| v1.00 | User_D | 1 | A4 | effective | ordinary | 2 in 1 | black & | 300 dpi | effective | tray 1/ | main tray |
| | | | | | sheet | | white | | | tray 2 | |

As can be seen from table 4, for user User_D a print driver of a version of v1.00 is permitted. Note that the restriction information of the print driver of this version is identical to that of the standard restriction information. Furthermore in table 4 the print driver corresponding to user User_D differs from those corresponding to the other user. More specifically, the former's password information ends without the term “custom”. This means that the print driver corresponding to this password information is uncustomized.

In step S5 CPU 101 provides a stetting indicating that there is no restriction information for the user logged in information terminal 200, and notifies information terminal 200 thereof.

In response to the notification CPU 201 proceeds to SA12 to receive an input of information selected for each item of restriction information and proceeds to step SA13. In step SA13, as will be described hereinafter, job information is transmitted to server 100. More specifically, by the notification transmitted at step S5 indicating no change, the information terminal is permitted to generate and transmit job information.

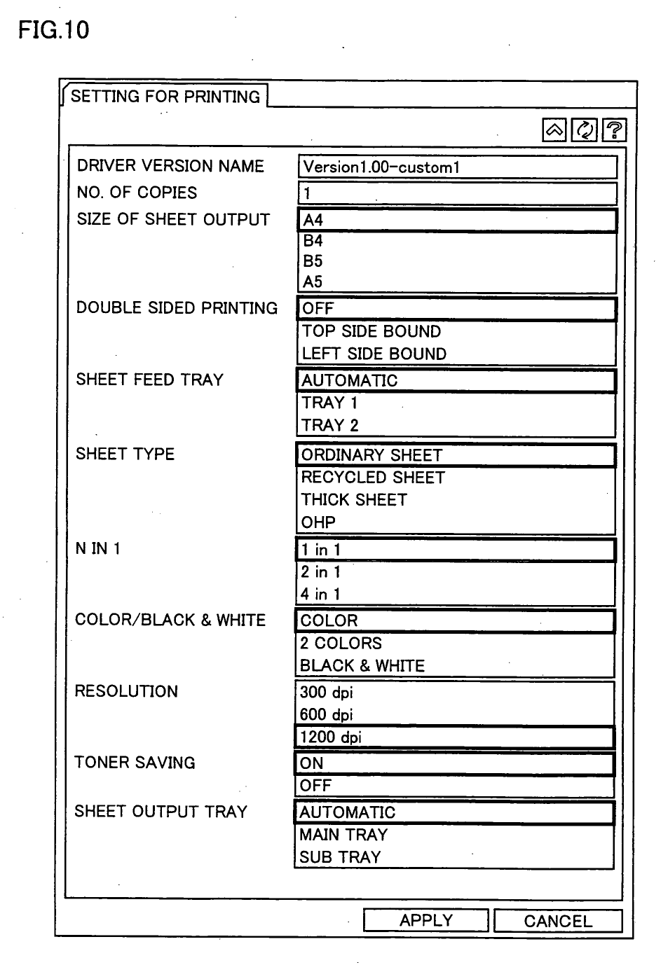

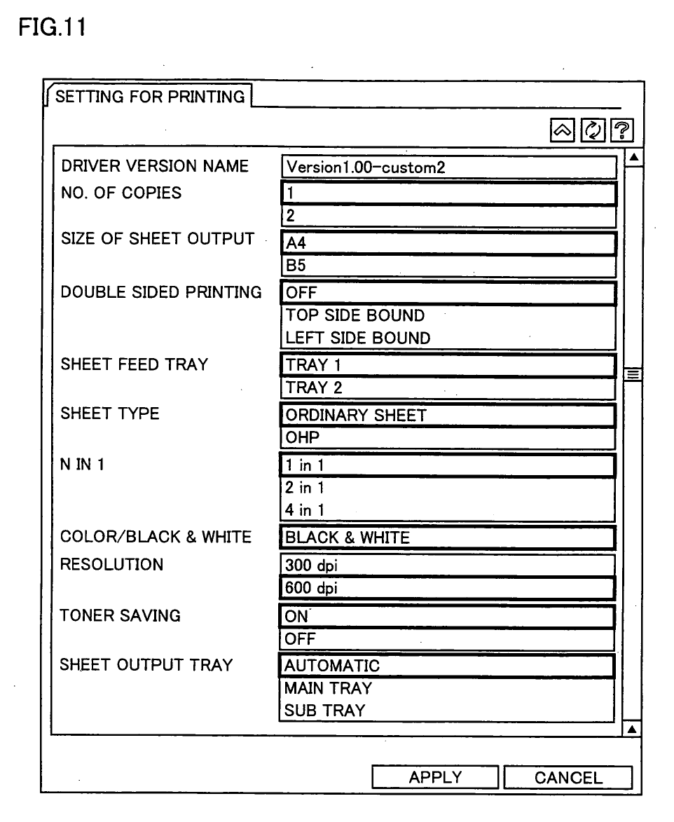

Note that if an input of information selected for each item of the restriction information is received, display 207 is controlled to display such a screen as shown in FIG. 10 or 11 to be operated to receive the input. FIGS. 10 and 11 show screens in accordance with restriction information corresponding to password information “v1.00-custom1” and “v1.00-custom2”, respectively. Note that on these screens, password information is indicated as “driver version name”. Furthermore the screens shown in FIGS. 10 and 11 have a variety of differences because their corresponding print driver have difference. For example, the FIG. 10 screen is adapted to allow any numerical value to be input as a number of copies, while the FIG. 11 screen is adapted to allow a numerical value of “1” of “2” to be input as a number of copies.

In step SA13 the information received at step SA12 is used to generate job information which (or a print job) is in turn transmitted to server 100.

In response to the transmission of the job information CPU 101 proceeds to S16 to receive the print job via communication device 11 and effects a process for causing image formation apparatus 300 to print as based on the print job (or job information).

In the above described embodiment, information terminal 200 transmits driver information to server 100 before job information is transmitted. Server 100 receives the driver information, and if password information, a user ID number and restriction information are stored in association with password information that is determined to be stored in the printing information stored in data storage 122, server 100 notifies information terminal 200 of prescribed information. Information terminal 100 receives the notification of the information, and transmits the job information to server 100.

Furthermore, in the above described embodiment, password information set for each print driver's manner of customization configures setting identification information.

Furthermore in the above described embodiment while the process described with reference to FIGS. 5-9 is started by starting a print driver in information terminal 200, the present print system is in configuration not limited thereto. For example, the process may be executed as information terminal 200 has a print driver started and furthermore an operation is performed to issue an instruction to start printing. Note that if the operation is performed, the process described with reference to FIGS. 5-9 is effected and thereafter job information is transmitted from information terminal 200 to server 100, as appropriate.

Furthermore, in the above described embodiment, server 100, information terminal 200 and image formation apparatus 300 configure an information processor, an information terminal and a printer, respectively. Note that the process indicated in FIGS. 5-9 that is executed by CPU 101 of server 100 may be executed by CPU 301 of image formation apparatus 300. In that case, image formation apparatus 300 will configure the information processor.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of controlling a print system including a printer, an information terminal and an information processor, said information terminal storing driver identification information serving as information for identifying a driver generating job information for operating said printer, said information processor receiving job information transmitted from said information terminal, and causing said printer to perform a print operation based on said job information received, the method comprising the steps of:
transmitting said driver identification information from said information terminal to said information processor prior to transmitting said job information;
making a decision in said information processor as to whether said driver identification information received from said information terminal is appropriate information; and
after said information terminal has received a decision that said driver identification information transmitted is appropriate information, transmitting said job information from said information terminal to said information processor.

2. The method according to claim 1, further comprising the step of storing said driver identification information in said information processor, wherein in the step of making, said information processor determines whether said driver identification information received from said information terminal matches driver identification information stored in said information processor.

3. The method according to claim 2, further comprising the steps of:
storing in said information processor a specific restriction on printing in association with said driver identification information; and
if said information processor determines that said driver identification information received from said information terminal is not appropriate information, transmitting to said information terminal said driver identification information appropriate and a specific restriction stored in association with said driver identification information appropriate.

4. The method according to claim 1, further comprising the step of storing said driver identification information in said information processor in association with user information, wherein in the step of making, said information processor determines whether said driver identification information received from said information terminal is stored in said information processor in association with user information of a user having transmitted said driver identification information.

5. The method according to claim 4, further comprising the steps of:
storing in said information processor a specific restriction on printing in association with said driver identification information;
storing said specific restriction in said information terminal;
transmitting said specific restriction from said information terminal together with said driver identification information; and
if said information processor determines that said driver identification information received from said information terminal is not stored in said information processor in association with said user information of the user having transmitted said driver identification information, then updating a storage to associate said received driver identification information with said user information of the user having transmitted said driver identification information and said specific restriction transmitted therewith.

6. The method according to claim 4, further comprising the steps of:
storing said driver identification information in said information processor in association with a specific restriction on printing;
storing said specific restriction in said information terminal;
transmitting said specific restriction from said information terminal together with said driver identification information; and
if said information processor determines that said driver identification information received from said information terminal is stored in said information processor in association with said user information of the user having transmitted said driver identification information and said specific restriction received from said information terminal is not stored in association with said driver identification information transmitted therewith, then transmitting to said information terminal said specific restriction stored in association with said driver identification information received from said information terminal.

7. The method according to claim 1, wherein said print system includes an image formation apparatus including said information processor and said printer.

8. An information processor connected to a printer and an information terminal, said information terminal storing driver identification information serving as information for identifying a driver generating job information for operating said printer, the information processor comprising:
a receiver receiving job information transmitted from said information terminal;
an executor executing a process, as based on said job information, to cause said printer to effect a print operation;
a determinator determining whether said driver identification information transmitted by said information terminal before said job information is transmitted is appropriate information; and
a notifier providing a permission to said information terminal to issue a job if said determinator determines that said driver identification information-received from said information terminal is appropriate information.

9. The information processor according to claim 8, further comprising a storage storing said driver identification information, wherein said determinator determines whether said driver identification information received from said information terminal is appropriate information from whether said driver identification information received from said information terminal matches said driver identification information stored in said storage.

10. The information processor according to claim 9, said storage storing a specific restriction on printing in association with said driver identification information, the information processor further comprising a first transmitter transmitting to said information terminal said driver identification information appropriate and a specific restriction stored in association with said driver identification information appropriate if said determinator determines that said driver identification information received from said information terminal is inappropriate.

11. The information processor according to claim 8, wherein:
said storage stores user information in association with said driver identification information; and
said determinator determines whether said driver identification information received from said information terminal is stored in said storage in association with user information of a user having transmitted said driver identification information.

12. The information processor according to claim 11, wherein:
said storage stores a specific restriction on printing in association with said driver identification information; and
if said determinator determines that said driver identification information received from said information terminal is not stored in said storage in association with said user information of the user having transmitted said driver identification information, said storage is updated to associate with said driver identification information received said user information of the user having transmitted said driver identification information and said specific restriction transmitted therewith.

13. The information processor according to claim 11, said storage storing a specific restriction on printing in association with said driver identification information, said determinator further determining whether said storage also stores in association said driver identification information received from said information terminal and said specific restriction transmitted therewith, the information processor further comprising a second transmitter transmitting to said information terminal said specific restriction stored in said storage in association with said driver identification information received from said information terminal, if said determinator determines that said driver identification information received from said information terminal is stored in said storage in association with said user information of the user having transmitted said driver identification information and said specific restriction received from said information terminal is not stored in said storage in association with said driver identification information transmitted therewith.

14. An information terminal transmitting job information to an information processor to cause a printer to print as based on said job information, comprising:
a storage storing driver identification information serving as information for identifying a driver generating job information for operating said printer;
a transmitter transmitting said driver identification information stored in said storage to said information processor before said job information is transmitted;
a receiver receiving notification from said information processor that said driver identification information transmitted at said transmitter is appropriate information; and
a job transmitter transmitting said job information to said information processor after said receiver receives said notification.

15. The information terminal according to claim 14, wherein:
said storage further stores user identification information serving as information identifying a user; and
said transmitter transmits said user identification information together with said driver identification information to said information processor.

16. The information terminal according to claim 14, said storage further storing a specific restriction on printing, the information terminal further comprising:
a receiver receiving said specific restriction transmitted from said information processor; and
an updater updating said specific stored in said storage to be said specific restriction received by said receiver.

17. A program product for controlling an information processor connected to a printer and an information terminal, said information terminal storing driver identification information serving as information for identifying a driver generating job information for operating said printer, the information processor including a receiver receiving job information transmitted from said information terminal and an executor executing a process, as based on said job information, to cause said printer to effect a print operation, the program product causing said information processor to execute the steps of:
determining whether said driver identification information transmitted by said information terminal before said job information is transmitted is appropriate information; and
if a decision is made that said driver identification information received from said information terminal is appropriate information, then providing a permission to said information terminal to issue a job.

18. A program product for controlling an information terminal transmitting job information to an information processor to cause a printer to print as based on said job information, the program product causing said information terminal to execute the steps of:
storing driver identification information serving as information for identifying a driver generating job information for operating said printer;
transmitting said driver identification information to said information processor before said job information is transmitted;
receiving notification from said information processor that said driver identification information transmitted is appropriate information; and
transmitting said job information to said information processor after said notification is received.
